(19) United States
(12) Patent Application Publication
(10) Pub. No.: US 2021/0200284 A1
(43) Pub. Date: Jul. 1, 2021

(54) IMAGE DISPLAY DEVICE, POWER SUPPLY SYSTEM, AND POWER SUPPLY METHOD FOR IMAGE DISPLAY DEVICE

(71) Applicant: SEIKO EPSON CORPORATION, Tokyo (JP)

(72) Inventor: Yutaka FUJIMAKI, MATSUMOTO-SHI (JP)

(73) Assignee: SEIKO EPSON CORPORATION, Tokyo (JP)

(21) Appl. No.: 17/133,682

(22) Filed: Dec. 24, 2020

(30) Foreign Application Priority Data
Dec. 26, 2019 (JP) 2019-235890

(51) Int. Cl. G06F 1/18; G02B 27/01; H01M 10/48

(52) U.S. Cl. CPC G06F 1/189; G02B 27/017; H01M 2220/30; G02B 2027/0178; H01M 10/488

(57) ABSTRACT

A control device includes a first interface configured to transmit an image signal and receive power, a second interface A configured to receive power, a second interface B, a detection circuit configured to detect a connection of an external device, an internal battery, and a CO control unit configured to charge the internal battery with power supplied from the external device connected to the first interface when a connection of the external device to the first interface and at least one of the plurality of second interfaces is detected and the connected device is operable as a source.

The present application is based on, and claims priority from JP Application Serial Number 2019-235890, filed Dec. 26, 2019, the disclosure of which is hereby incorporated by reference herein in its entirety.

### BACKGROUND

### 1. Technical Field

The present disclosure relates to an image display device, a power supply system, and a power supply method for an image display device.

### 2. Related Art

In recent years, data communication buses such as USBs are increasingly used for data communication as well as for supplying and receiving power. JP-A-2011-34601 discloses an information processing device which performs power supply suitable for a device to which power is supplied.

A case in which a plurality of ports are provided in an image display device, a plurality of external devices are connected to the image display device, and data communication and power supply/reception are performed with the plurality of external devices is conceivable. When the plurality of external devices are connected to the plurality of ports of the image display device and are supplied with power from the connected external devices, the external devices may be connected to an internal battery included in the image display device, a short circuit may occur, and power supply may not be appropriately performed.

### SUMMARY

An aspect for solving the above-described problem is an image display device which displays an image, including: a first interface configured to transmit an image signal for an image and receive power, a plurality of second interfaces configured to receive power, a detection unit configured to detect a connections of external devices to the first interface and the plurality of second interfaces, an internal battery, and a control unit configured to perform switching of the interfaces, wherein, when a connection of an external device to the first interface and at least one of the plurality of second interfaces is detected and the device connected to the first interface and the second interface is operable as a source, the control unit charges the internal battery with power supplied from the external device connected to the first interface.

Another aspect for solving the above-described problem is a power supply system including an image display device configured to display an image, and a battery device configured to supply power to the image display device,

wherein the image display device includes a first interface configured to transmit an image signal for an image and receiving power, a plurality of second interfaces configured to receive power, a detection unit configured to detect a connections of external devices to the first interface and the plurality of second interfaces;

an internal battery, and a control unit configured to perform switching of the interfaces, when a connection of an external device to the first interface and at least one of the plurality of second interfaces is detected and the device connected to the first interface and the second interface is operable as a source, the control unit charges the internal battery with power supplied from the external device connected to the first interface, and the plurality of second interfaces include a first power receiving interface configured to receive power supplied from the battery device, and a second power receiving interface disposed at a position at which a port for connection to an external device is hidden by the battery device when the battery device is connected to the first power receiving interface.

Yet another aspect for solving the above-described problem is a power supply method for an image display device configured to display an image, including detecting a connection of an external device to a first interface configured to transmit an image signal for an image and receiving power and a plurality of second interfaces configured to receive power; and charging an internal battery included in the image display device with power supplied from the external device connected to the first interface when the connection of the external device to the first interface and at least one of the plurality of second interfaces is detected and the device connected to the first interface and the second interface is operable as a source.

### BRIEF DESCRIPTION OF THE DRAWINGS

FIG. 1 is a diagram showing a schematic configuration of a display system.

FIG. 2 is a plan view of a main portion showing a configuration of an optical system of an image display unit.

FIG. 3 is a block diagram of the display system.

FIG. 4 is a block diagram of a control device.

FIG. 5 is a diagram showing an example of connections of a CO control unit and a power supply IC with each interface.

FIG. 6 is a diagram showing an example of a connection between a control device and an external device.

FIG. 7 is a diagram showing an example of the connection between the control device and the external device.

FIG. 8 is a diagram showing an example of the connection between the control device and the external device.

FIG. 9 is a diagram showing an example of the connection between the control device and the external device.

FIG. 10 is a diagram showing an example of the connection between the control device and the external device.

FIG. 11 is a flowchart showing an operation of the control device.

FIG. 12 is a diagram showing an example of an image displayed on a touch panel.

### DESCRIPTION OF EXEMPLARY EMBODIMENTS

### 1. Configuration of Display System

Hereinafter, exemplary embodiments to which the disclosure is applied will be described with reference to the accompanying drawings.

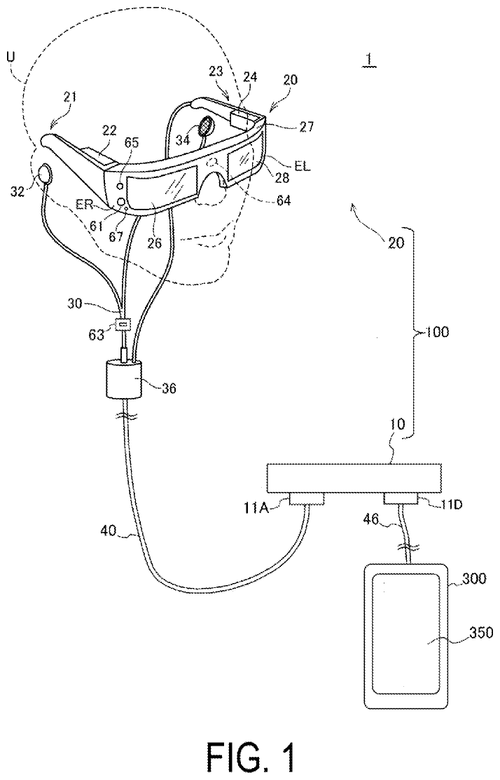

FIG. 1 is a diagram showing a schematic configuration of a display system 1.

The display system 1 includes an HMD 100 and a control device 300. The HMD 100 is a head-mounted display device which includes an image display unit 20 mounted on a head portion of a user U to allow the user to view images and videos. “HMD” is an abbreviation for “head mounted display”. The display system 1 corresponds to a power supply system of the present disclosure.

The HMD 100 includes a connection device 10 connected to the image display unit 20. The connection device 10 serves as an interface which connects the HMD 100 to a device other than the HMD 100. In the display system 1, the control device 300 is connected to the connection device 10.

In the following description and drawings, for the sake of convenience of description, a prefix DP is added to names of some functional parts constituting the HMD 100, and a prefix CO is added to names of some functional parts constituting the control device 300.

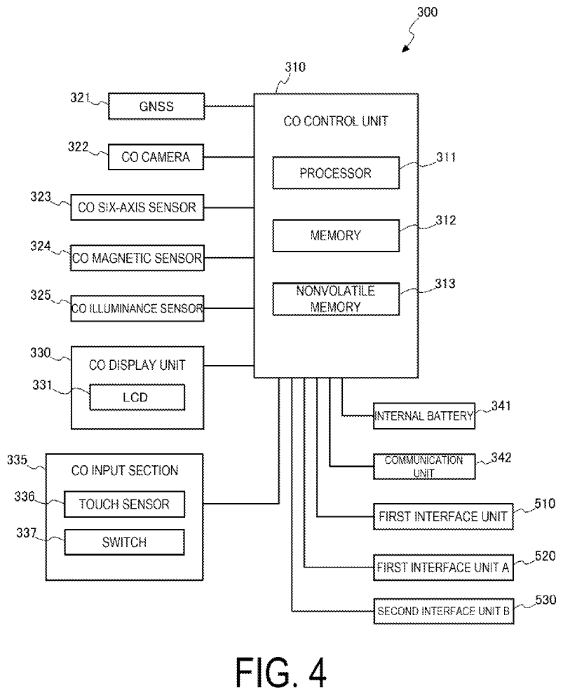

The control device 300 is a portable size terminal device including a display screen which displays text and images, and a touch panel 350 which serves as an operation unit for detecting a touch operation and a pressing operation, and for example, a smart phone can be used. The touch panel 350 is constituted by an LCD 331 and a touch sensor 336 which will be described below with reference to FIG. 4. “LCD” is an abbreviation for “liquid crystal display”. The control device 300 corresponds to an example of the image display device of the present disclosure. The image display device may be a desktop personal computer, a notebook personal computer, a tablet personal computer, or the like.

The connection device 10 includes a connector 11A and a connector 11D in a box shaped case. The image display unit 20 is connected to the connector 11A via a connection cable 40, and the control device 300 is connected to the connector 11D via a USB cable 46. Thus, the image display unit 20 and the control device 300 are connected to each other so that data can be transmitted and received therebetween. For example, the control device 300 outputs video data for the image display unit 20 to display a video or outputs audio data to the image display unit 20. For example, the image display unit 20 transmits detection data of various sensors included in the image display unit 20 to the control device 300, as will be described later. The control device 300 may be capable of supplying power to the image display unit 20. Here, “USB” is an abbreviation for “universal serial bus”.

The configuration in which the connection device 10 and the control device 300 are connected using the USB cable 46 is merely an example, and a specific connection form between the connection device 10 and the control device 300 is not limited. For example, the connection device 10 and the control device 300 may be connected through a wire connection using other types of cables, or may be connected via wireless communication. For example, in a configuration in which the USB cable 46 is connected to the connector 11D of a USB-Type C standard, a direct current of 20 volts can be supplied by the USB cable 46, and HDMI standard video data or the like can be transmitted as a function of an alternation mode of the USB-Type C. HDMI and MHL are registered trademarks.

The image display unit 20 includes a main body including a right holding part 21, a left holding part 23, and a front frame 27. The main body further includes a right display unit 22, a left display unit 24, a right light-guiding plate 26, and a left light-guiding plate 28.

The right holding part 21 and the left holding part 23 extend rearward from both end portions of the front frame 27 and hold the image display unit 20 on the head portion of the user U. The right holding part 21 is connected to an end portion Er of the front frame 27 located on the right side of the user U, and the left holding part 23 is connected to an end portion EL thereof located on the left side of the user U.

The right light-guiding plate 26 and the left light-guiding plate 28 are provided on the front frame 27. The right light-guiding plate 26 is located in front of the right eye of the user in a state in which the image display unit 20 is mounted, and allows the user to see an image with the right eye. The left light-guiding plate 28 is located in front of the left eye of the user in a state in which the image display unit 20 is mounted, and allows the user to see an image with the left eye. The right light-guiding plate 26 and the left light-guiding plate 28 are optical parts formed of a light transmissive resin or the like, and are configured to guide imaging light output by the right display unit 22 and the left display unit 24 to the eyes of the user. The right light-guiding plate 26 and the left light-guiding plate 28 are, for example, prisms.

The front frame 27 has a shape formed by connecting an end of the right light-guiding plate 26 and an end of the left light-guiding plate 28 to each other, and this connecting position corresponds to a position between the eyebrows of the user in a mounted state in which the user U wears the image display unit 20. The front frame 27 may include a nose pad part which is in contact with the nose of the user U in the mounted state of the image display unit 20, and may be configured to connect a belt to the right holding part 21 and the left holding part 23 to hold the image display unit 20 to the head portion of the user U by the belt.

Each of the right display unit 22 and the left display unit 24 is a module obtained by unitizing an optical unit and a peripheral circuit. The right display unit 22 displays an image with the right light-guiding plate 26, and the left display unit 24 displays an image with the left light-guiding plate 28. The right display unit 22 is provided at the right holding part 21, and the left display unit 24 is provided at the left holding part 23.

The imaging light guided by the right light-guiding plate 26 and outside light transmitted through the right light-guiding plate 26 are incident on the right eye of the user U. Similarly, the imaging light guided by the left light-guiding plate 28 and outside light transmitted through the left light-guiding plate 28 are incident on the left eye. The imaging light from the right light-guiding plate 26 and the left light-guiding plate 28 and the outside light transmitted through the right light-guiding plate 26 and the left light-guiding plate 28 are incident on the eyes of the user U. Thus, the user U sees the image displayed by the image display unit 20 and an outside scene transmitted through the right light-guiding plate 26 and the left light-guiding plate 28 in an overlapping manner.

A DP illuminance sensor 65 is disposed on the front frame 27. The DP illuminance sensor 65 is a sensor configured to receive outside light from in front of the user U who wears the image display unit 20. An illumination and an amount of outside light transmitted through the right light-guiding plate 26 and the left light-guiding plate 28 and incident on the eyes of the user U can be detected by the DP illuminance sensor 65.

A DP outer camera 61 is provided at a position on the front frame 27 at which it does not block the outside light transmitted through the right light-guiding plate 26 and the left light-guiding plate 28. The DP outer camera 61 is a digital camera including an image capturing element such as a CCD and a CMOS, an image capturing lens, and the like, and may be a monocular camera or a stereo camera. A field angle of the DP outer camera 61 includes at least a part of an extent of an outside scene visible to the user U wearing the image display unit 20 through the right light-guiding plate 26 and the left light-guiding plate 28. The DP outer camera 61 may be a wide-angle camera or a camera which can capture an image of the entire outside scene seen by the user U wearing the image display unit 20. “CCD” is an abbreviation for “charge coupled device”, and “CMOS” is an abbreviation for “complementary metal oxide semiconductor”. An LED indicator 67 configured to light up while the DP outer camera 61 is operated is disposed on the front frame 27.

A distance sensor 64 which detects a distance between a measurement target object located in a predetermined measurement direction and the distance sensor 64 is provided on the front frame 27. The distance sensor 64 is, for example, a light reflective distance sensor using an LED, a laser diode or the like, an infrared depth sensor, an ultrasonic distance sensor, or a laser range scanner. The distance sensor 64 may be a distance detection unit in which image detection and sound detection are combined, or a device in which a distance is detected by processing images obtained by stereo imaging using a camera. The measurement direction of the distance sensor 64 is, for example, a direction of the outside scene seen by the user U through the right light-guiding plate 26 and the left light-guiding plate 28.

Each of the right display unit 22 and the left display unit 24 is connected to the connection device 10 by the connection cable 40. The connection cable 40 includes an audio connector 36. A headset 30 including a right earphone 32 and a left earphone 34 constituting a stereo headphone, and a microphone 63 is connected to the audio connector 36. The right earphone 32 and the left earphone 34 output a sound based on a sound signal output from the connection device 10. The microphone 63 is configured to collect a sound and to output a sound signal to the connection device 10.

### 2. Configuration of Optical System of Image Display Unit

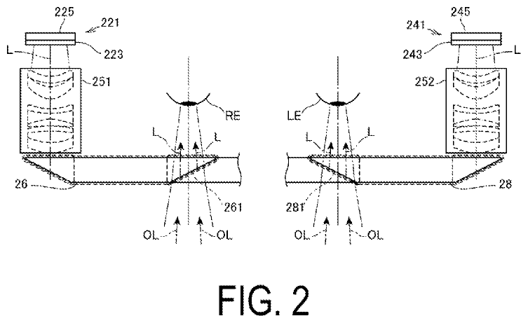

FIG. 2 is a plan view showing a main portion of a configuration of an optical system of the image display unit 20. In FIG. 2, the left eye LE and the right eye RE of the user U are shown for explanation.

The right display unit 22 and the left display unit 24 are configured to be bilaterally symmetrical, for example.

The right display unit 22 includes an OLED unit 221 which emits imaging light, and a right optical system 251 which guides the imaging light L emitted by the OLED unit 221 to the right light-guiding plate 26, as a configuration for allowing the right eye RE to see the image. “OLED” is an abbreviation for “organic light emitting diode”.

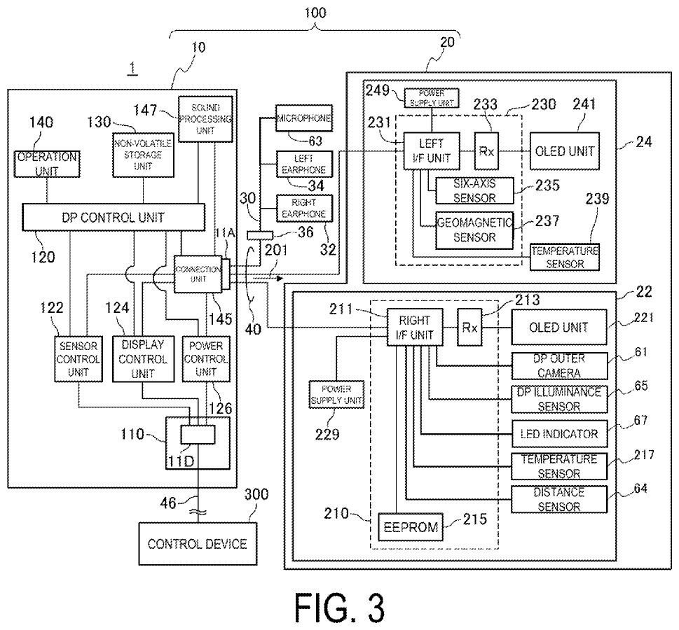

The OLED unit 221 includes an OLED panel 223 and an OLED drive circuit 225 configured to drive the OLED panel 223. The OLED panel 223 is, for example, a self-light-emitting type display panel in which light emitting elements that emit R, G, and B lights are disposed. The OLED drive circuit 225 drives the OLED panel 223 in accordance with control of a DP control unit 120. The OLED drive circuit 225 is mounted on a substrate (not shown) fixed to a back surface of the OLED panel 223, for example, and a temperature sensor 217 shown in FIG. 3 is mounted on the substrate.

The right optical system 251 makes the imaging light L emitted from the OLED panel 223 into a parallel light flux by a collimator lens and causes it to be incident on the right light-guiding plate 26. In the right light-guiding plate 26, the imaging light L is reflected by a plurality of reflecting surfaces, is reflected by a half mirror 261 located in front of the right eye RE, and is then emitted from the right light-guiding plate 26 toward the right eye RE.

The left display unit 24 includes an OLED unit 241 which emits imaging light, and a left optical system 252 which guides the imaging light L emitted by the OLED unit 241 to the left light-guiding plate 28, as a configuration for allowing the left eye LE to see an image.

The OLED unit 241 includes an OLED panel 243, and an OLED drive circuit 245 configured to drive the OLED panel 243. The OLED panel 243 is, for example, a self-light-emitting type display panel in which light emitting elements that emit R, G, and B lights are disposed. The OLED drive circuit 245 drives the OLED panel 243 in accordance with the control of the DP control unit 120. The OLED drive circuit 245 is mounted on a substrate (not shown) fixed to a back surface of the OLED panel 243, for example, and a temperature sensor 239 shown in FIG. 3 is mounted on the substrate.

The left optical system 252 makes the imaging light L emitted from the OLED panel 243 into a parallel light flux by a collimator lens and causes it to be incident on the left light-guiding plate 28. In the left light-guiding plate 28, the imaging light L is reflected by a plurality of reflecting surfaces, is reflected by a half mirror 281 located in front of the left eye LE, and is then emitted from the left light-guiding plate 28 toward the left eye LE.

The HMD 100 serves as a see-through type display device. That is, the imaging light L reflected by the half mirror 261 and outside light OL transmitted through the right light-guiding plate 26 are incident on the right eye RE of the user U. The imaging light L reflected by the half mirror 281 and the outside light OL transmitted through the half mirror 281 are incident on the left eye LE. The HMD 100 allows the imaging light L of the internally processed image and the outside light OL to be incident on the eyes of the user U in an overlapping manner. Therefore, the user U can see the outside scene through the right light-guiding plate 26 and the left light-guiding plate 28, and the image due to the imaging light L is seen in the overlapping manner with the outside scene. Each of the half mirrors 261 and 281 is an image extracting unit configured to reflect the imaging light output by each of the right display unit 22 and the left display unit 24 and to extract an image, and constitutes a display unit.

### 3. Control System of HMD

FIG. 3 is a block diagram of the display system 1 and particularly shows a configuration of the HMD 100 in detail.

The right display unit 22 of the image display unit 20 includes a right display unit substrate 210. A right I/F unit 211 connected to the connection cable 40, a receiving unit 213 which receives data input from the connection device 10 via the right I/F unit 211, and an EEPROM 215 are mounted on the right display unit substrate 210. The right I/F unit 211 connects the receiving unit 213, the EEPROM 215, the temperature sensor 217, the DP outer camera 61, the distance sensor 64, the DP illuminance sensor 65, and the LED indicator 67 to the connection device 10. The receiving unit 213 connects the OLED unit 221 to the connection device 10.

The left display unit 24 includes a left display unit substrate 230. A left I/F unit 231 connected to the connection cable 40 and a receiving unit 233 which receives data input from the connection device 10 via the left I/F unit 231 are mounted on the left display unit substrate 230. Further, a DP six-axis sensor 235 and a DP magnetic sensor 237 are mounted on the left display unit substrate 230.

The left I/F unit 231 connects the receiving unit 233, the DP six-axis sensor 235, the DP magnetic sensor 237, and the temperature sensor 239 to the connection device 10. The receiving unit 233 connects the OLED unit 241 to the connection device 10.

In the description and drawings of the embodiment, “EEPROM” is an abbreviation for “electrically erasable programmable read-only memory”. The receiving unit 213 and the receiving unit 233 may be referred to as Rx213 and Rx233, respectively.

The EEPROM 215 is configured to store various types of data in a non-volatile manner. The EEPROM 215 stores, for example, data about light-emitting properties and display properties of the OLED units 221 and 241 provided in the image display unit 20, and data about a property of a sensor provided in the right display unit 22 or the left display unit 24. Specifically, the EEPROM 215 stores parameters related to gamma correction of the OLED units 221 and 241, data used to compensate detection values of the temperature sensors 217 and 239, and the like so that the DP control unit 120 can read them.

The DP outer camera 61 captures an image in accordance with a signal input via the right I/F unit 211 and outputs captured image data to the right I/F unit 211. The DP illuminance sensor 65 is configured to receive the outside light and to output a detection value corresponding to an amount of the received light or an intensity of the received light. The LED indicator 67 is configured to light up in accordance with a control signal or a driving current input via the right I/F unit 211.

The temperature sensor 217 is configured to detect a temperature of the OLED unit 221 and to output a voltage value or a resistance value corresponding to the detected temperature as a detection value.

The distance sensor 64 is configured output a signal which indicates a detection result obtained by detecting a distance to the connection device 10 via the right I/F unit 211.

The receiving unit 213 is configured to receive video data for display transmitted from the connection device 10 via the right I/F unit 211 and to output the video data to the OLED unit 221. The OLED unit 221 displays a video based on the video data transmitted by the connection device 10.

The receiving unit 233 is configured to receive video data for display transmitted from the connection device 10 via the left I/F unit 231 and to output the video data to the OLED unit 241. The OLED units 221 and 241 display a video based on the video data transmitted by the connection device 10.

The DP six-axis sensor 235 is a motion sensor including a three-axis acceleration sensor and a three-axis gyro sensor. The DP magnetic sensor 237 is a three-axis geomagnetic sensor, for example. The DP six-axis sensor 235 and the DP magnetic sensor 237 may be an IMU in which each of the above sensors is modularized and may be a module in which the DP six-axis sensor 235 and the DP magnetic sensor 237 are integrated. “IMU” is an abbreviation for “inertial measurement unit”. The temperature sensor 239 detects a temperature of the OLED unit 241. Each of the DP six-axis sensor 235, the DP magnetic sensor 237, and the temperature sensor 239 outputs a detection value to the connection device 10.

Each of the parts of the image display unit 20 operates with power supplied from the connection device 10 via the connection cable 40. The image display unit 20 includes a power supply unit 229 on the right display unit 22, and a power supply unit 249 on the left display unit 24. The power supply unit 229 is configured to distribute and supply the power supplied by the connection device 10 via the connection cable 40 to each of the parts of the right display unit 22 including the right display unit substrate 210. The power supply unit 249 is configured to distribute and supply the power supplied by the connection device 10 via the connection cable 40 to each of the parts of the left display unit 24 including the left display unit substrate 230. The power supply units 229 and 249 may include a conversion circuit or the like configured to convert a voltage.

The connection device 10 includes an I/F unit 110, a DP control unit 120, a sensor control unit 122, a display control unit 124, a power control unit 126, a non-volatile storage unit 130, an operation unit 140, a connection unit 145, and a sound processing unit 147.

The I/F unit 110 includes a connector 11D and an interface circuit which executes communication protocols conforming to various communication standards by the connector 11D. The I/F unit 110 may be, for example, an interface substrate on which the connector 11D and the interface circuit are mounted. The I/F unit 110 may include an interface for a memory card capable of being connected to an external storage device or storage medium, or the like, or the I/F unit 110 may be constituted of a radio communication interface.

The DP control unit 120 includes a processor such as a CPU or a microcomputer, and this processor controls each of the parts of the connection device 10 by executing a program. The DP control unit 120 may include a RAM constituting a work area for the processor. “RAM” is an abbreviation for “random access memory”.

The DP control unit 120 is connected to the non-volatile storage unit 130, the operation unit 140, the connection unit 145, and the sound processing unit 147. The non-volatile storage unit 130 is a ROM which stores a program executed by the DP control unit 120 or data in a non-volatile manner. “ROM” is an abbreviation for “read only memory”.

The sensor control unit 122 operates each of the sensors included in the image display unit 20. Here, the respective sensors are the DP outer camera 61, the distance sensor 64, the DP illuminance sensor 65, the temperature sensor 217, the DP six-axis sensor 235, the DP magnetic sensor 237, and the temperature sensor 239. Each of the sensors includes at least one or more of the DP outer camera 61, the DP illuminance sensor 65, the DP six-axis sensor 235, and the DP magnetic sensor 237. The sensor control unit 122 is configured to perform setting and initialization of a sampling period of each of the sensors according to the control of the DP control unit 120, and to perform energization to each of the sensors, transmission of control data, acquisition of a detection value, and the like in accordance with the sampling period of each of the sensors.

The sensor control unit 122 outputs detection data indicative of the detection value and the detection result of each of the sensors to the I/F unit 110 at a preset timing. Here, the captured image data of the DP outer camera 61 is referred to as detection data, like the detection values and detection results of the other sensors.

The sensor control unit 122 may include an A/D converter which converts an analog signal into digital data. In this case, the sensor control unit 122 is configured to convert the detection value obtained from the sensor of the image display unit 20 or the analog signal of the detection result into detection data and to output the detection data. The sensor control unit 122 may acquire the detection value or the digital data of the detection result from the sensor of the image display unit 20, may perform conversion of a data format, adjustment of an output timing, and the like, and then may output the detection data to the I/F unit 110.

The control device 300 connected to the I/F unit 110 can acquire the detection value of each of the sensors of the HMD 100 or the captured image data of the DP outer camera 61 through an operation of the sensor control unit 122.

The sensor control unit 122 may output results of an arithmetic operation based on the detection value of each of the above-described sensors as the detection data. For example, the sensor control unit 122 may be configured to integrally process the detection values or detection results of a plurality of sensors and to serve as a so-called sensor fusion processing unit. In this case, the sensor control unit 122 may generate detection data of a virtual sensor not included in any of the sensors of the image display unit 20 due to the sensor fusion. For example, the sensor control unit 122 may output trajectory data indicating a moving trajectory of the image display unit 20, coordinate data indicating a position of the image display unit 20 in a three-dimensional space, and directional data indicating a direction of the image display unit 20 as the detection data. Here, the coordinate data may be data indicating relative coordinates with respect to a position of the connection device 10, or may be data indicating a position with respect to a reference position set in a space in which the image display unit 20 is present. The direction data may be data indicating a direction based on a position and a direction of the connection device 10, or may be data indicating a direction with respect to a reference position set in the space in which the image display unit 20 is present.

The sensor control unit 122 executes communication protocols between the sensor control unit 122 and a device connected to the connector 11D by the USB cable 46 and outputs detection data.

The display control unit 124 is configured to perform various kinds of processing for the image display unit 20 to display an image based on video data or display data input to the I/F unit 110. In the present embodiment, the video data is transmitted in the alternation mode of the USB-Type C through the connector 11D constituted of a USB-Type C connector. The display control unit 124 is configured to perform various kinds of processing such as frame extraction, resolution conversion, scaling, intermediate frame generation, frame rate conversion, and the like. The display control unit 124 is configured to output video data corresponding to each of the OLED units 221 and 241 to the connection unit 145. The video data input to the connection unit 145 is transmitted as an image signal 201 from the connector 11A to the right I/F unit 211 and the left I/F unit 231. The display control unit 124 adjusts and changes a display state of the image display unit 20 in accordance with the display control data input to the I/F unit 110.

At least one of the sensor control unit 122 and the display control unit 124 may be realized by software and hardware in cooperation when a processor executes a program. That is, the sensor control unit 122 and the display control unit 124 are constituted by a processor, and the operations described above are performed by executing a program. In this example, the sensor control unit 122 and the display control unit 124 may be realized by a processor constituting the DP control unit 120 executing a program. In other words, the processor may serve as the DP control unit 120, the display control unit 124 and the sensor control unit 122 by executing the program. Here, the processor can be paraphrased as a computer. Each of the sensor control unit 122 and the display control unit 124 may include a work memory for performing data processing and may perform the processing using a memory of the DP control unit 120.

The display control unit 124 and the sensor control unit 122 may be constituted of programmed hardware such as DSP, FPGA or the like. The sensor control unit 122 and the display control unit 124 may be integrated and constituted as an SoC-FPGA. “DSP” is an abbreviation for “digital signal processor”, “FPGA” is an abbreviation for “field programmable gate array”, and “SoC” is an abbreviation for “system-on-a-chip”.

The power control unit 126 is a circuit which is connected to the connector 11D and supplies power to each of the connection device 10 and the image display unit 20 based on the power supplied from the connector 11D.

The operation unit 140 is configured to detect an operation of a switch or the like included in the connection device 10 and to output data indicating operation content to the DP control unit 120.

The sound processing unit 147 is configured to generate a sound signal in accordance with sound data input from the DP control unit 120 and to output the sound signal to the connection unit 145. This sound signal is output from the connection unit 145 to the right earphone 32 and the left earphone 34 via the audio connector 36. The sound processing unit 147 is configured to generate sound data of the sound collected by the microphone 63 and to output the sound data to the DP control unit 120. The sound data output by the sound processing unit 147 may be processed by the sensor control unit 122, like the detection data of the sensor included in the image display unit 20.

### 4. Configuration of Control Device

FIG. 4 is a block diagram of the control device 300.

The control device 300 includes a CO control unit 310. The CO control unit 310 includes a processor 311, a memory 312, and a non-volatile memory 313. The processor 311 may be constituted of a CPU, a microcomputer, a DSP, and the like and is configured to control each of parts of the control device 300 by executing a program. The memory 312 forms a work area of the processor 311. The non-volatile memory 313 is constituted of a semiconductor memory device or the like, and is configured to store a program executed by the processor 311 and various kinds of data to be processed by the processor 311 in a non-volatile manner. For example, the non-volatile memory 313 stores an operating system serving as a basic control program executed by the processor 311, an application program which operates on the operating system, and the like. The non-volatile memory 313 is configured to store data processed during execution of the application program, data of processing results, and the like. The CO control unit 310 may be a SoC in which the processor 311, the memory 312, and the non-volatile memory 313 are integrated.

A GNSS 321, a CO camera 322, a CO six-axis sensor 323, a CO magnetic sensor 324, a CO illuminance sensor 325, a CO display unit 330, and a CO input unit 335 are connected to the CO control unit 310.

The GNSS 321 performs positioning using a satellite positioning system and outputs a position of the control device 300 to the CO control unit 310. “GNSS” is an abbreviation for “global navigation satellite system”.

The CO camera 322 is a digital camera provided on a main body of the control device 300, is disposed adjacent to the touch panel 350, for example, and captures an image in a direction facing the touch panel 350. The CO camera 322 is configured to capture an image in accordance with control of the CO control unit 310 and to output captured image data to the CO control unit 310.

The CO six-axis sensor 323 is a motion sensor including a three-axis acceleration sensor and a three-axis gyro sensor, and outputs detection data indicating a detection value to the CO control unit 310. The CO magnetic sensor 324 is, for example, a three-axis geomagnetic sensor, and outputs detection data indicating a detection value to the CO control unit 310. The CO six-axis sensor 323 and the CO magnetic sensor 324 may be an IMU in which each of the above-described sensors is modularized, and may be a module in which the CO six-axis sensor 323 and the CO magnetic sensor 324 are integrated.

The CO illuminance sensor 325 is configured to receive the outside light and to output detection data indicating a detection value corresponding to an amount of the received light or an intensity of the received light to the CO control unit 310.

The CO display unit 330 has the LCD 331 and displays characters or images on the LCD 331 in accordance with the control of the CO control unit 310.

The CO input unit 335 is configured to detect an operation on the touch sensor 336 and the switch 337 and to output operation data indicating a detected operation to the CO control unit 310. The touch sensor 336 is disposed to be superimposed on a surface of the LCD 331 and constitutes the touch panel 350 together with LCD 331. The touch sensor 336 detects a contact operation or a pressing operation by the user U. The switch 337 is a hardware switch such as, for example, a power switch, a volume adjustment switch, or the like of the control device 300.

An internal battery 341, a communication unit 342, a first interface 510, a second interface A 520, and a second interface B 530 are connected to the CO control unit 310.

The internal battery 341 is a secondary battery built into the main body of the control device 300 and supplies power to each of the parts of the control device 300. The internal battery 341 may include a control circuit (not shown) which controls an output of power and charging to the secondary battery.

The communication unit 342 corresponds to a wireless communication protocol such as Bluetooth or Wi-Fi and performs wireless communication with a device outside the display system 1. The Bluetooth and Wi-Fi are registered trademarks. The communication unit 342 may be configured to perform mobile data communication using a mobile communication network such as LTE or a fifth generation mobile communication system. The LTE is a registered trademark.

The control device 300 includes a plurality of interfaces. The control device 300 according to the present embodiment includes three interfaces which are a first interface 510, a second interface A 520, and a second interface B 530.

The first interface 510 is an interface conforming to the USB Type-C standard. The first interface 510 is an interface corresponding to transmission and reception of data signals, supply of power to a connected external device, and reception of power supplied from the outside. The external device capable of being connected to the first interface 510 includes the HMD 100 and a mobile battery 710, for example. It is also possible to connect an input device such as a digital camera, a QR code reader, an SD card, a mouse, a key, or the like to the first interface 510. QR is a registered trademark.

Also, the first interface 510 corresponds to an alternate mode. The alternate mode is a mode in which a USB 3.1 Gen 1-compatible data signal line can be operated as another standard signal line. It is assumed that the HMD 100 is connected to a first USB port 511 of the first interface 510. When the CO control unit 310 outputs an image signal to HMD 100, the signal line used to transmit and receive the data signal is operated as a DisplayPort signal line, and a terminal provided on the first USB port 511 of the first interface 510 is operated in a DisplayPort alternate mode. Thus, an image signal is output to the HMD 100 which is an external device connected to the first interface 510.

The first interface 510 includes the first USB port 511 and a detection circuit 513. A terminal for signal transmission, a terminal for signal reception, a terminal supporting USB 2.0 such as D+ or D−, a VBUS terminal, a GND terminal, a CC terminal, and the like are provided in the first USB port 511.

The detection circuit 513 corresponds to an example of a detection unit and detects a change in a voltage of a CC terminal provided in the first USB port 511. The detection circuit 513 detects the connection of the external device to the first USB port 511 on the basis of the detected change in the voltage of the CC terminal. Further, the detection circuit 513 determines whether the setting of the external device connected to the first USB port 511 is a source or a sink based on the detected voltage of the CC terminal. The source means a power supply source, and the sink means the consumable side which consumes power. “CC” is an abbreviation for “configuration channel”, and the CC terminal includes a plurality of terminals of CC1 and CC2. The detection circuit 513 outputs a signal indicating the detection result to the CO control unit 310.

The second interface A 520 is also an interface conforming to the USB Type-C standard. The second interface A 520 is an interface corresponding to the transmission and reception of data signals, the supply of power to the outside, and the reception of power supplied from the outside. Also, the second interface A 520 does not correspond to the alternate mode. The mobile battery 710 can be connected as an external device to the second interface A 520. It is also possible to connect an input device such as a digital camera, a QR code reader, an SD card, a mouse, a key, or the like to the second interface A 520. Further, the second interface A 520 corresponds to a second power receiving interface of the present disclosure.

The second interface A 520 includes a second USB port 521 and a detection circuit 523. The detection circuit 523 detects a change in a voltage of the CC terminal provided in the second USB port 521. The detection circuit 523 detects the connection of the external device to second USB port 521 due to the detected change in the voltage of the CC terminal. The detection circuit 523 outputs a signal indicating the detection result to the CO control unit 310. The detection circuit 523 corresponds to an example of the detection unit according to the present disclosure. Also, the second USB port 521 corresponds to a port for connection according to the present disclosure.

The second interface B 530 is an interface to which an optional battery 730 can be connected as an external device. The second interface B 530 includes a contact terminal 531 and a detection circuit 533. The second interface B 530 corresponds to a first power receiving interface of the present disclosure.

The second interface B 530 is an interface dedicated to charging. For example, a pogo pin is used for the contact terminal 531. The pogo pin has a spring property and stretches and contracts when it is in contact with a contact terminal provided on an external device. Signal lines of VBus, D+, D− and Grand of USB 2.0 are respectively connected to contact terminal 531. Further, the contact terminal 531 has a terminal used for connection detection of the external device, and the detection circuit 533 detects the connection of the external device to the second interface B 530 due to a change in a voltage of the terminal. The detection circuit 533 outputs a signal indicating the detection result to the CO control unit 310.

The external device connected to the second interface B 530 is the optional battery 730 which is a dedicated battery prepared as an option. The optional battery 730 has a metal pad 750 which comes into contact with the contact terminal 531 upon connection to the control device 300, and when the contact terminal 531 comes into contact with the metal pad 750, the power supplied from the optional battery 730 is received. The metal pad 750 corresponds to a power supply terminal of the present disclosure.

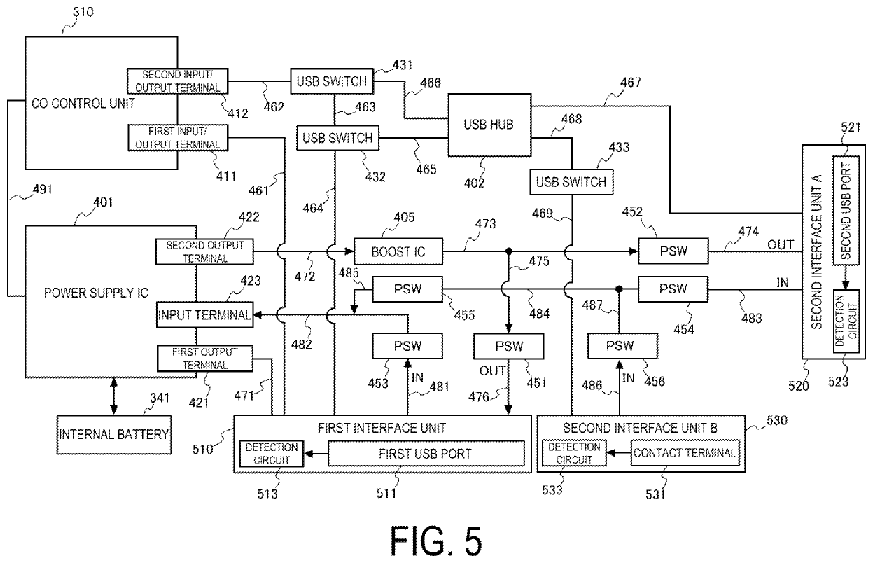

FIG. 5 is a diagram showing an example of a connection between the CO control unit 310 of the control device 300 and a power supply IC 401 and each of the interfaces.

The CO control unit 310, the first interface 510, the second interface A 520, and the second interface B 530 are respectively connected by data lines for performing data communication.

The CO control unit 310 and the first interface 510 are connected by a data line 461. The CO control unit 310 includes a first input/output terminal 411. A differential signal line which transmits and receives serial data corresponding to a USB Super Speed mode is connected to the first input/output terminal 411. Further, the first input/output terminal 411 corresponds to the DisplayPort alternate mode and is used as a terminal through which an image signal is output.

Furthermore, the CO control unit 310 and the first interface 510 are connected via a USB switch 431 and a USB switch 432. The CO control unit 310 includes a second input/output terminal 412. A signal line conforming to the USB 2.0 standard is connected to the second input/output terminal 412. The second input/output terminal 412 and the USB switch 431 are connected by a data line 462. The USB switch 431 and the USB switch 432 are connected by a data line 463. The USB switch 432 and a first USB port 515 are connected by a data line 464.

The CO control unit 310 and the second interface A 520 are connected via the USB switch 431 and a USB hub 402.

The second input/output terminal 412 and the USB switch 431 are connected by the data line 462. The USB switch 431 and the USB hub 402 are connected by a data line 466. The USB hub 402 and the second interface A 520 are connected by a data line 467.

The CO control unit 310 and the second interface B 530 are connected via the USB switch 431, the USB hub 402, and a USB switch 433.

The second input/output terminal 412 and the USB switch 431 are connected by the data line 462. The USB switch 431 and the USB hub 402 are connected by the data line 466. The USB hub 402 and the USB switch 433 are connected by a data line 468. Also, the USB switch 433 and the second interface B 530 are connected by a data line 469.

Next, the connection between the power supply IC 401, the first interface 510, the second interface A 520, and the second interface B 530 will be described.

The power supply IC 401 is connected to the internal battery 341 and controls charging to the internal battery 341 and supply of power charged in the internal battery 341. The power supply IC 401 is connected to the CO control unit 310 via a power source line 491 and supplies a system power supply, which operates the CO control unit 310, to the CO control unit 310.

Further, the power supply IC 401 includes a first output terminal 421 and a second output terminal 422 as terminals which outputs power to the outside, and includes an input terminal 423 as a terminal which receives power supplied from outside.

The first output terminal 421 corresponds to the USB PD standard and is connected to the first interface 510 by a power source line 471. “PD” is an abbreviation for “power delivery”. In the following description, the power source line corresponds to a power supply path of the present disclosure.

The second output terminal 422 is connected to the first interface 510 and the second interface A 520.

The second output terminal 422 and the first interface 510 are connected via a boost IC 405 and a PSW 451. The boost IC 405 is a circuit which boosts a voltage supplied from the power supply IC 401. “PSW” is an abbreviation for “power switch”.

The second output terminal 422 and the boost IC 405 are connected by a power source line 472. The boost IC 405 and the PSW 451 are connected by a power source line 473 and a power source line 475 connected to the power source line 473. The PSW 451 and the first interface 510 are connected by a power source line 476.

The second output terminal 422 and the second interface A 520 are connected via the boost IC 405 and a PSW 452.

The second output terminal 422 and the boost IC 405 are connected by the power source line 472. The boost IC 405 and the PSW 452 are connected by the power source line 473. The PSW 452 and the second interface A 520 are connected by a power source line 474.

The input terminal 423 is connected to the first interface 510, the second interface A 520, and the second interface B 530.

The first interface 510 and the input terminal 423 are connected via a PSW 453. The first interface 510 and the PSW 453 are connected by a power source line 481. The PSW 453 and the input terminal 423 are connected by a power source line 482. The PSW 453 corresponds to a switch of the present disclosure.

The second interface A 520 and the input terminal 423 are connected via a PSW 454 and a PSW 455. The second interface A 520 and the PSW 454 are connected by a power source line 483. The PSW 454 and the PSW 455 are connected by a power source line 484. The PSW 455 and the input terminals 423 are connected by a power source line 485 and a power source line 482. The PSW 454 and the PSW 455 correspond to switches of the present disclosure.

The second interface B 530 and the input terminal 423 are connected via a PSW 456 and the PSW 455. The second interface B 530 and the PSW 456 are connected by a power source line 486. The PSW 456 and the PSW 455 are connected by power source lines 487 and 484. The PSW 455 and the input terminals 423 are connected by the power source line 485 and the power source line 482. The PSW 456 and the PSW 455 correspond to switches of the present disclosure.

The detection results of the detection circuits 513, 523 and 533 are input to the CO control unit 310. The CO control unit 310 controls the USB switches 431 to 433 and the PSW 451 to 456 based on the input detection results and switches between an output destination of the data signal, a supply destination to which power is supplied, a power receiving destination in which power is received, and the like.

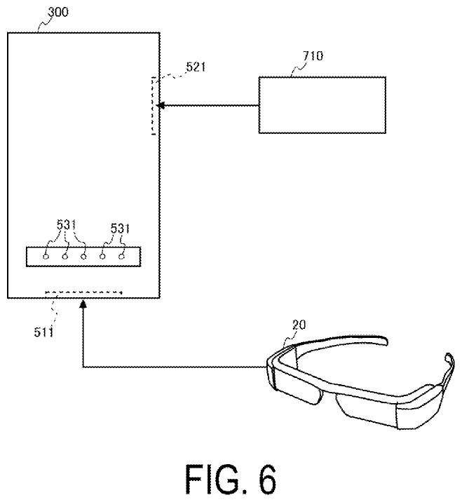

FIG. 6 is a diagram showing an example of a connection between the control device 300 and the external device.

FIG. 6 shows a case in which the HMD 100 is connected to the first USB port 511 and the mobile battery 710 is connected to the second USB port 521.

An image signal can be output from the control device 300 to the HMD 100, and a video based on the image signal can be displayed on the image display unit 20 of the HMD 100 by operating the first interface 510 in the alternate mode. The CO control unit 310 outputs the image signal to the first interface 510 via the first input/output terminal 411.

Further, the internal battery 341 can be charged with the power supplied from the mobile battery 710 by connecting the mobile battery 710 to the second USB port 521. When the setting of the HMD 100 connected to the first USB port 511 is a sink, the CO control unit 310 switches the PSW to receive power supplied from the mobile battery 710 connected to the second USB port 521. The CO control unit 310 sets the PSWs 454 and 455 to be switched on and sets the PSWs 453 and 456 to be switched off.

A priority is set for the first interface 510, the second interface A 520, and the second interface B 530. This priority is a priority for charging power supplied to the control device 300. The priority of the first interface 510 is set to be higher than the priorities of the second interface A 520 and the second interface B 530.

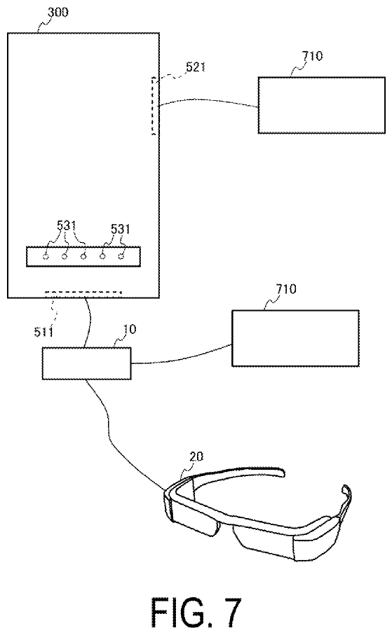

For example, as shown in FIG. 7, it is assumed that the HMD 100 and the mobile battery 710 are connected to the connection device 10 connected to the first USB port 511 of the first interface 510. Further, it is assumed that the mobile battery 710 is also connected to the second USB port 531 of the second interface A 520. When the mobile battery 710 can also be operated as a source, the CO control unit 310 selects the mobile battery 710 connected to the connection device 10 and charges the internal battery 341 with the power supplied from the selected mobile battery 710. In this case, the CO control unit 310 sets the PSW 453 to be switched on and sets the PSWs 454 to 456 to be switched off.

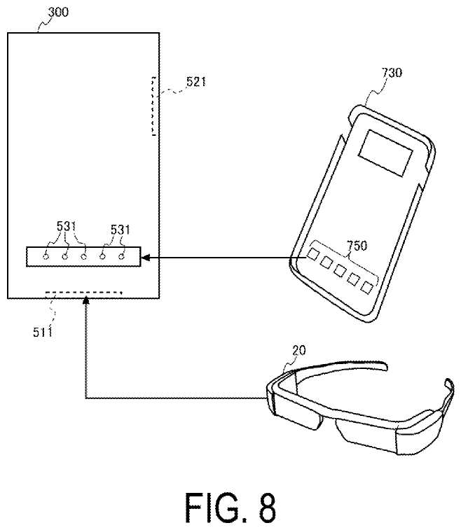

FIG. 8 is a diagram showing an example of a connection between the control device 300 and the external device.

FIG. 8 shows a case in which the HMD 100 is connected to the first USB port 511 and the optional battery 730 which is a battery optionally prepared is connected to the contact terminal 531 of the second interface B 530. In this case as well, like the connection example shown in FIG. 6, an image signal is output from the control device 300 to the HMD 100, and an image based on the image signal is displayed on the image display unit 20 of the HMD 100. The optional battery 730 encloses the control device 300 when being connected to the control device 300. Specifically, when the optional battery 730 is connected to the control device 300, the optional battery 730 is in contact with the control device 300 at each of upper, lower, left, and right side surfaces of the control device 300. In addition, a plurality of metal pads 750 are disposed at contact positions in contact with the contact terminals 531 provided on a back surface of the control device 300. The contact terminal 531 is constituted of a pogo pin, and the contact terminal 531 stretches and contracts when the contact terminal 531 is in contact with the metal pad 750. Stretching and contracting of the contact terminal 531 can increase reliability of contact between the contact terminal 531 and the metal pad 750.

In the case of the connection example shown in FIG. 8 as well, when the setting of the HMD 100 connected to the first USB port 511 is a sink, the CO control unit 310 switches the PSW to receive power supplied from the optional battery 730 connected to the contact terminal 531 of the second interface B 530. The CO control unit 310 sets the PSW 456 to be switched on and sets the PSWs 453 to 455 to be switched off.

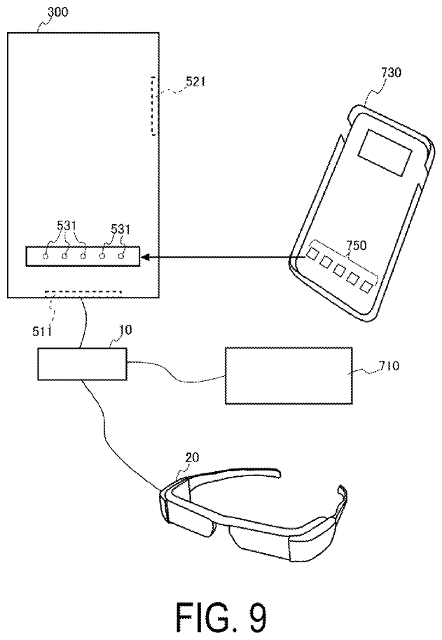

Further, as shown in FIG. 9, it is assumed that the HMD 100 and the mobile battery 710 are connected to the connection device 10 connected to the first USB port 511 of the first interface 510. It is also assumed that the optional battery 730 is connected to the contact terminal 531 of the second interface B 530. In the first interface 510 and the second interface B 530, the priority of the first interface 510 is higher than that of the second interface B 530. In this case, when both the mobile battery 710 and the optional battery 730 can be operated as sources, the CO control unit 310 selects the mobile battery 710 connected to the connection device 10 and charges the internal battery 341 with the power supplied from the selected mobile battery 710. The CO control unit 310 sets the PSW 453 to be switched on and sets the PSWs 454 to 456 to be switched off.

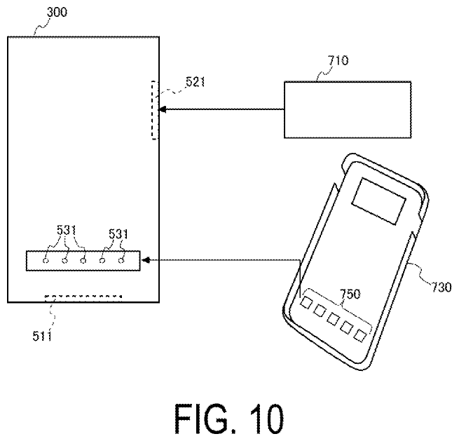

FIG. 10 is a diagram showing an example of a connection between the control device 300 and the external device.

FIG. 10 shows a case in which the mobile battery 710 is connected to the second USB port 521 and the optional battery 730 is connected to the contact terminal 531.

In the present embodiment, the priority of the second interface A 520 is higher than the priority of the second interface B 530. When the source is connected to the second interface A 520 and the second interface B 530, the CO control unit 310 switches the PSW to receive power supplied from the mobile battery 710 connected to the second USB port 521. The CO control unit 310 sets the PSWs 454 and 455 to be switched on and sets the PSWs 453 and 456 to be switched off.

In a state in which the optional battery 730 is connected to the contact terminal 531 of the second interface B 530, a restriction may be provided so that the mobile battery 710 cannot be connected to the second USB port 521 of the second interface A 520. For example, when the optional battery 730 is connected to the control device 300, the optional battery 730 may physically hide the second USB port 521 to prevent the external device from being connected to the second USB port 521. Accordingly, the second USB port 521 of the second interface A 520 and the contact terminal 531 of the second interface B 530 can be prevented from being connected simultaneously to the battery. Also, since the second USB port 521 is hidden by the optional battery 730, intrusion of dust or the like into the second USB port 521 can be curbed. The optional battery 730 corresponds to a battery device of the present disclosure.

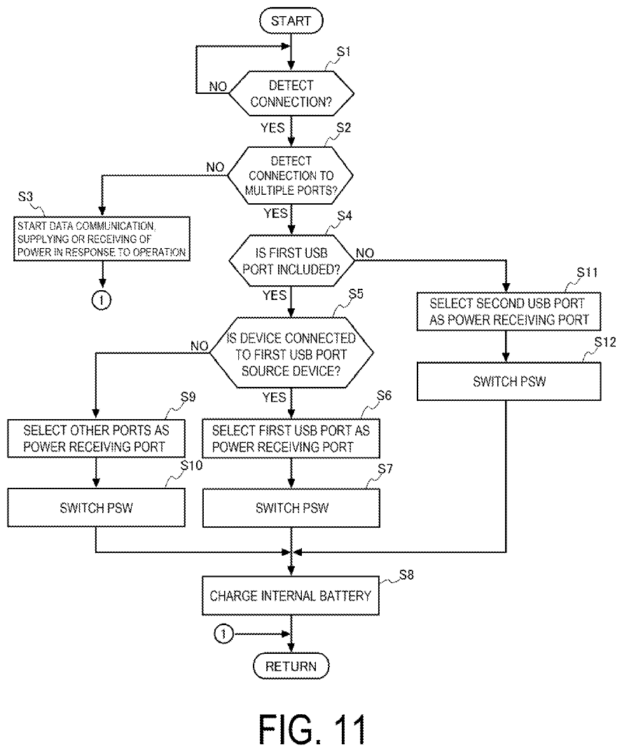

FIG. 11 is a flowchart showing an operation of the CO control unit 310.

The operation of the CO control unit 310 will be described with reference to the flowchart shown in FIG. 11.

The detection results of the detection circuits 513, 523 and 533 are input to the CO control unit 310. The CO control unit 310 determines whether or not there is a port at which the connection of the external device is detected based on the input detection results (Step S1). When the determination in Step S1 is No, the CO control unit 310 returns to the determination of Step S1. Also, when the determination in Step S1 is Yes, the CO control unit 310 determines whether or not the port at which the connection of the external device is detected is multiple (Step S2).

When the determination in Step S2 is No, the CO control unit 310 performs an operation corresponding to the connected external device (Step S3). For example, when a portable battery is connected as the external device, the CO control unit 310 causes the interface to receive power supplied from the portable battery and charges the internal battery 341 with the received power. Further, when the HMD 100 is connected as the external device, the CO control unit 310 causes the image signal to be output to the HMD 100 in accordance with an operation of an operator. In addition, when a sink device is connected as the external device, the CO control unit 310 supplies the power charged in the internal battery 341 to the external device in accordance with the operation of the operator.

Also, when the determination in Step S2 is Yes, the CO control unit 310 determines whether or not the first USB port 511 is included in the port at which the connection is detected (Step S4). When the determination in Step S4 is Yes, the CO control unit 310 determines whether or not the external device connected to the first USB port 511 is a source device (Step S5).

When the determination in Step S5 is No, the CO control unit 310 selects another port other than the first USB port 511 as the power receiving port through which power is received (Step S9). The port is a port detected by the determination of Step S2. The CO control unit 310 switches the PSWs on and off so that power supplied from the external device connected to the selected power receiving port is input to the power supply IC 401 (Step S10). Also, the CO control unit 310 causes the power supply IC 401 to charge the internal battery 341 (Step S8).

When the determination in Step S5 is Yes, the CO control unit 310 selects the first USB port 511 as the power receiving port (Step S6). The CO control unit 310 switches the PSW 451 on so that power supplied from the external device connected to the selected first USB port 511 is input to the power supply IC 401 (Step S7). Furthermore, the CO control unit 310 causes the power supply IC 401 to charge the internal battery 341 with the received power (Step S8).

In addition, when the determination in Step S4 is No, the CO control unit 310 selects the second USB port 521 as the power receiving port (Step S11). The CO control unit 310 switches the PSW 453 and the PSW 455 on so that power supplied from the external device connected to the selected second USB port 521 is input to the power supply IC 401 (Step S12). Furthermore, the CO control unit 310 causes the power supply IC 401 to charge the internal battery 341 with the received power (Step S8).

Also, the control device 300 includes a virtual device mode as a display mode. The virtual device mode is a mode in which the touch panel 350 is caused to serve as an input device such as a so-called game pad. The virtual device mode corresponds to a preset operation mode of the present disclosure.

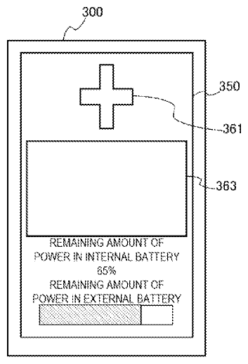

FIG. 12 shows a display example of the touch panel 350 in the virtual device mode.

In the virtual device mode, an input device screen is displayed on the touch panel 350. An object 361 which imitates a direction key and a guide image 363 showing a region serving as a track pad are displayed as display objects on the input device screen. The object 361 is an image which imitates a shape of a so-called cross key in which keys indicating directions of the top, bottom, left, and right are integrated. The user U performs the operation same as in the cross key by performing a touch operation on a position of the object 361. The user U performs the operation same as in the track pad by performing a touch operation within a frame of the guide image 363.

When the control device 300 is operated in the virtual device mode, the CO control unit 310 obtains a remaining amount of power charged to the internal battery 341 from the power supply IC 401. The CO control unit 310 causes the CO display unit 330 to display the acquired remaining amount of power.

Also, when the mobile battery 710 is connected to the second USB port 521, the CO control unit 310 performs data communication with the mobile battery 710 and acquires a remaining amount of power charged to the mobile battery 710.

In addition, when the optional battery 730 is connected to the contact terminal 531, the CO control unit 310 performs data communication with the optional battery 730 and acquires the remaining amount of power charged to the optional battery 730.

The CO control unit 310 causes the CO display unit 330 to display the acquired remaining amount of power. The CO control unit 310 causes the display of the remaining amount of power in the internal battery 341 and the display of the remaining amount of power in the mobile battery 710 or the optional battery 730 to be performed in different display modes. For example, the CO control unit 310 may change a color or size of the display in the display of the remaining amount of power in the internal battery 341 and the display of the remaining amount of power in the mobile battery 710 or the optional battery 730. Furthermore, the CO control unit 310 may change an icon or symbol indicating the remaining amount of power. FIG. 12 shows an example in which the remaining amount of power in the internal battery 341 is displayed as a percentage by a numerical value and the remaining amount of power in the mobile battery 710 or the optional battery 730 is displayed in a bar format.

Also, the CO control unit 310 obtains the sum of the remaining amount of power in the internal battery 341 and the remaining amount of power in the mobile battery 710 or the optional battery 730.

When the sum of the remaining amount of power in the internal battery 341 and the remaining amount of power in the mobile battery 710 or the optional battery 730 is less than or equal to a preset threshold value, the CO control unit 310 causes the HMD 100 to perform a notification operation. For example, the notification operation performed by the HMD 100 may cause the image display unit 20 to display a message notifying that the remaining amount of power in the battery is low. Also, the HMD 100 may output audio notifying that the remaining amount of power in the battery has dropped below the threshold value from the right earphone 32 and the left earphone 34. Also, a vibrator may be mounted on the HMD 100, and the notification operation may be performed by vibrating the vibrator. Also, the notification operation may be performed by lighting or blinking the LED indicator 67 provided on the front frame 27 of the HMD 100. In addition, the notification operation may be performed on a device other than the HMD 100. For example, the CO control unit 310 may transmit a predetermined signal to an earphone or a wearable device connected to the control device 300 through Bluetooth and may cause the earphone and the wearable device to vibrate.

### 5. Modified Example

Although FIG. 5 shows the case in which the second interface B 530 is an interface dedicated to charging, the second interface B 530 may be an interface capable of supplying and receiving power. For example, the mobile battery 710 is connected to the second interface A 520, and the optional battery 730 is connected to the second interface B 530. When an external device is connected to the second interface A 520 and the second interface B 530, the CO control unit 310 selects the second interface A 520 having a high priority. The CO control unit 310 sets the PSWs 454 and 455 to be switched on and sets the PSWs 453 and 456 to be switched off so that power supplied from the mobile battery 710 connected to the second USB port 521 is received.

Also, when 100% of power is charged to the internal battery 341 by the power supplied from the mobile battery 710, the CO control unit 310 may cause the power supplied from the mobile battery 710 to be supplied to the optional battery 730. The CO control unit 310 causes the power supply IC 401 to supply power supplied from the mobile battery 710 to the optional battery 730 connected to the second interface B 530. Thus, the optional battery 730 connected to the second interface B 530 can be charged by the mobile battery 710 connected to the second interface A 520.

As described above, the control device 300 according to the present embodiment is a device which displays an image and includes the first interface 510 and the plurality of second interfaces.

The first interface 510 is an interface capable of transmitting an image signal originating from an image and receiving power. The plurality of second interfaces are the second interface A 520 and the second interface B 530 capable of receiving power.

Also, the control device 300 includes the detection circuits 513, 523 and 533, the internal battery 341, and the CO control unit 310.

When the connection of the external device is detected at least one of the first interface 510, the second interface A 520, and the second interface B 530, the CO control unit 310 charges the internal battery 341 with power supplied from the external device connected to the first interface 510.

Accordingly, it is possible to curb a situation in which the external devices connected to the plurality of interfaces operate as source devices and a circuit-short occurs due to power supplied from the plurality of external devices. Also, the internal battery 341 can be charged with power supplied from the interface that transmits the image signal.

Further, in the control device 300, each of the first interface 510, the second interface A 520, and the second interface B 530 is connected to the internal battery 341 by a plurality of power source lines 471 to 476 and 481 to 487.

Also, the control device 300 includes the PSWs 451 to 456 which are provided in the plurality of power source lines 471 to 476 and 481 to 487 and switch the connection between each of the first interface 510, the second interface A 520, and the second interface B 530 and the internal battery 341.

Accordingly, any selected one of the first interface 510, the second interface A 520, and the second interface B 530 can be connected to the internal battery 341 by switching the PSWs 451 to 456.

Further, when the connection of the external device is detected at the second interface A 520 and the second interface B 530, the CO control unit 310 selects any one of the second interface A 520 and the second interface B 530 in accordance with the priority thereof.

The CO control unit 310 connects the selected second interface A 520 or second interface B 530 to the internal battery 341 by switching the switch. Furthermore, the CO control unit 310 does not connect the second interface B 530 or the second interface A 520 which is not selected to the internal battery 341.

Accordingly, the internal battery 341 can be charged with power supplied from the selected second interface A 520 or second interface B 530.

The second interface A 520 which is an interface capable of performing data communication with an external device is included in a plurality of second interfaces.

Accordingly, information can be acquired from the external device by performing the data communication with the external device.

The plurality of second interfaces include the second interface B 530 which includes a pogo pin as the contact terminal 531 and receives power supplied from the external device when the metal pad 750 provided on the external device comes into contact with the contact terminal 531.

Therefore, the power supplied from the external device can be received by bringing the contact terminal 531 into contact with the metal pad 750.

Further, the first interface 510 conforms to the USB Type-C standard.

In the control device 300, a connector provided on the first USB port 511 is configured to be operated in the DisplayPort alternate mode.

Accordingly, the image signal can be supplied from the control device 300 to the HMD 100 via the first interface 510.

The control device 300 includes the CO display unit 330 as a display unit.

When the external battery is connected to at least one of the first interface 510, the second interface A 520, and the second interface B 530, the CO control unit 310 obtains the remaining amount of power in the connected external battery. The CO control unit 310 causes the CO display unit 330 to display the acquired remaining amount of power.

Accordingly, the remaining amount of power in the external battery can be displayed on the CO display unit 330.

Further, the CO control unit 310 acquires the remaining amount of power in the internal battery 341 and causes the acquired remaining amount of power in the external battery and the remaining amount of power in the internal battery 341 to be displayed on the CO display unit 330 in different display modes.

Accordingly, it is easy to distinguish the remaining amount of power in the external battery from the remaining amount of power in the internal battery 341 displayed on the CO display unit 330.

Also, in the CO control unit 310, the HMD 100 is connected to the first interface 510, the external battery is connected to the second interface A 520 or the second interface B 530, and when an operation mode of the control device 300 is the virtual device mode, the remaining amount of power in the external battery and the remaining amount of power in the internal battery 341 are displayed on the CO display unit 330.

Also, when the sum of the remaining amount of power in the external battery and the remaining amount of power in the internal battery 341 is less than or equal to a preset threshold value, the CO control unit 310 causes the HMD 100 to perform a notification operation.

Accordingly, it is possible to notify the user U of the HMD 100 that the remaining amount of power in each of the external battery and the internal battery 341 has decreased.

The present disclosure is not limited to the configurations in the exemplary embodiments described above, and the present disclosure can be implemented in various aspects without departing from the gist thereof.

For example, although the configuration in which the display system 1 includes the HMD 100 which is a head-mounted display device has been exemplified, the present disclosure is not limited thereto, and various types of display devices can be employed. For example, instead of the image display unit 20, for example, another type of image display unit such as an image display unit to be worn like a cap may be employed, and such an image display unit may include a display unit configured to display images corresponding to the left eye LE of the user U and a display unit configured to display images corresponding to the right eye RE of the user U. Additionally, the display device in the present disclosure may be configured, for example, as a head-mounted display mounted in a vehicle such as a car, and an airplane. Further, the display device may be configured, for example, as a head-mounted display built into a body protector tool such as a helmet. In such a case, a portion for positioning the device with respect to the body of the user U, and a portion positioned with respect to the portion can be a mounting part of the head-mounted display device.

The HMD 100 is an example of a display device to which the present disclosure is applied and is not limited to the configuration shown in FIG. 3. The configuration in which the image display unit 20 and the connection device 10 are separated has been described as an example in the exemplary embodiment, but a configuration in which the connection device 10 and the image display unit 20 are integrally configured and mounted on the head of the user U can be employed. Further, the configuration of the optical system of the image display unit 20 is optional, and for example, an optical member located in front of the eyes of the user U and overlapping some or all of the field of view of the user U may be used. Alternatively, a scanning type optical system in which laser light or the like is scanned to form imaging light may be adopted. Alternatively, the present disclosure is not limited to one which guides imaging light inside the optical member and may have only a function of guiding an imaging light by refracting and/or reflecting the imaging light toward the eyes of the user U.

Also, a liquid crystal monitor or a liquid crystal television which displays an image on a liquid crystal display panel may be adopted as the display device. A display device including a plasma display panel and an organic EL display panel may be used. In this case, the display panel corresponds to the display unit of the present disclosure. Also, a projector which projects imaging light onto a screen or the like may be used as the display device.

Further, for example, in the HMD 100 shown in FIG. 3, the connection device 10 may be configured using a USB-Type C connector, a USB-Type C controller, and a USB hub. In this case, the DP outer camera 61 and other sensors may be connected to the USB hub. Also, as a controller for controlling display of the right display unit 22 and the left display unit 24 in the image display unit 20, a FPGA which outputs display data to the right display unit 22 and the left display unit 24 may be disposed at any one of the right display unit 22 and the left display unit 24. In this case, the connection device 10 may include a bridge controller which connects the USB-Type C controller to the FPGA. Additionally, the image display unit 20 may have a configuration in which the DP six-axis sensor 235, the DP magnetic sensor 237, the EEPROM 215, and the like are mounted on the substrate same as the FPGA. The arrangement of the other sensors can also be changed accordingly. For example, a configuration in which the distance sensor 64 and the DP illuminance sensor 65 are disposed at positions suitable for measurement or detection and are connected to the FPGA or the USB-Type C controller may be employed.

Moreover, there is no limitation on specific specifications of the display device including the OLED units 221 and 241, and for example, the OLED units 221 and 241 may have a common configuration.

At least some of the functional blocks shown in FIGS. 3 and 4 may be realized in hardware or may be realized by hardware and software in cooperation, and the present disclosure is not limited to a configuration in which independent hardware resources are disposed as shown in the drawings. In addition, the program executed by the processor 311 may be configured so that the program stored in an external device is acquired via the communication unit 342 or the I/F unit 343 and then executed.

What is claimed is:

1. An image display device for displaying an image, the image display device comprising:
a first interface configured to transmit an image signal for an image and receive power;
a plurality of second interfaces configured to receive power;
a detection unit configured to detect connections of external devices to the first interface and the plurality of second interfaces;
an internal battery; and
a control unit configured to perform switching of the interfaces, wherein
when connections of external devices to the first interface and at least one of the plurality of second interfaces are detected and apparatuses connected to the first interface and the second interface are operable as sources, the control unit charges the internal battery with power supplied from an external device connected to the first interface.

2. The image display device according to claim 1, comprising:
a plurality of power supply paths configured to connect the internal battery to each of the first interface and the plurality of second interfaces; and
a plurality of switches provided in each of the plurality of power supply paths and configured to perform switching of a connection between the internal battery and each of the first interface and the plurality of second interfaces.

3. The image display device of claim 2, wherein
when a connection of an external device is detected at at least two second interfaces, the control unit selects any one of the two second interfaces in accordance with a preset priority, connects the selected second interface to the internal battery by switching the switch and does not connect the unselected second interface to the internal battery.

4. The image display device according to claim 1, wherein
the plurality of second interfaces include an interface configured to perform data communication with an external device.

5. The image display device according to claim 1, wherein
the plurality of second interfaces include an interface having a contact terminal that has a spring property and comes into contact with a power supply terminal of an external device to receive power supplied from the external device.

6. The image display device according to claim 1, wherein
the first interface conforms to a USB-Type C standard, and the image display device configures a connector included in the first interface and configured to operate in a DisplayPort alternate mode.

7. The image display device according to claim 1, further comprising a display unit, wherein
when an external battery is connected to the first interface and at least one of the plurality of second interfaces, the control unit acquires a remaining amount of power in the connected external battery and causes the display unit to display the acquired remaining amount of power.

8. The image display device according to claim 7, wherein
the control unit acquires a remaining amount of power in the internal battery and causes the display unit to display the acquired remaining amount of power in the external battery and the remaining amount of power in the internal battery in different display modes.

9. The image display device according to claim 8, wherein
when a head-mounted display device is connected as an external device to the first interface, an external battery is connected to any one of the plurality of second interfaces, and an operation mode of the image display device is a preset operation mode, the control unit causes the display unit to display the remaining amount of power in the external battery and the remaining amount of power in the internal battery, and
when a sum of the remaining amount of power in the external battery and the remaining amount of power in the internal battery is less than or equal to a preset threshold value, the control unit causes the head-mounted display device to perform a notification operation.

10. A power supply system comprising an image display device configured to display an image, and a battery device configured to supply power to the image display device, wherein
the image display device includes:
a first interface configured to transmit an image signal for an image and receive power;
a plurality of second interfaces configured to receive power;
a detection unit configured to detect connections of external devices to the first interface and the plurality of second interfaces;
an internal battery; and
a control unit configured to perform switching of the interfaces, and
when connections of external devices to the first interface and at least one of the plurality of second interfaces are detected and devices connected to the first interface and the second interface are operable as sources, the control unit charges the internal battery with power supplied from an external device connected to the first interface, and
the plurality of second interfaces include:
a first power receiving interface configured to receive power supplied from the battery device; and
a second power receiving interface with a port for connection to an external device, the port being disposed at a position at which the port is hidden by the battery device when the battery device is connected to the first power receiving interface.

11. A power supply method for an image display device for displaying an image, the method comprising:
detecting a connection of an external device to a first interface configured to transmit an image signal for an image and receive power and a plurality of second interfaces configured to receive power; and
charging an internal battery included in the image display device with power supplied from an external device connected to the first interface when connections of external devices to the first interface and at least one of the plurality of second interfaces are detected and apparatuses connected to the first interface and the second interface are operable as sources.
